(19) United States
(12) Patent Application Publication
(10) Pub. No.: US 2008/0270798 A1
(43) Pub. Date: Oct. 30, 2008

(54) Anonymous Authentification Method

(76) Inventors: Olivier Charles, Paris (FR); David Arditti, Clamart (FR); Sebastien Nguyen Ngoc, Chatillon (FR); Thierry Baritaud, Courbevoie (FR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/593,124

(22) PCT Filed: Mar. 4, 2005
(86) PCT No.: PCT/FR2005/000528

§ 371 Date: Nov. 22, 2006

(30) Foreign Application Priority Data
Mar. 16, 2004 (FR) 0402674

(51) Int. Cl. H04L 9/00

(52) U.S. Cl. 713/176

(57) ABSTRACT

An authentication method based on an encryption algorithm with a secret key. According to the invention, the anonymity of the entity being authenticated is guaranteed, so that only a legitimate authentication entity may recognize the identity of the entity which is being authenticated.

The present invention relates to an authentication method by secret key of at least one user, for example in view of authorising or not this user to access resources when the anonymity of the user who is being authenticated is required.

In the present description, the range of resources must be taken with very wide acceptance and generally designates any function, application, service, data set which a user can access and whereof access is conditioned by prior authorisation supplied on completing an authentication procedure. By way of non-limiting example, this can be a service provided by a specialised server, a function of access to a network, an information resource such as a database or a software application available on a server and capable of being shared by several users.

In general, authentication is a security service carried out by an authentication entity, whereof the objective is to validate the identity of a user wishing to be identified, bringing proof of the legitimacy of this user to access resources in question. An authentication entity commonly designates any equipment, machine or computer system which centralises an authentication process and which is accessible by users wishing to be authenticated for access to resources, via a telecommunications network.

Usually, a user wishing to trigger an authentication process has a client entity allowing him to communicate with the authentication entity. A client entity in the present description designates any electronic system or equipment for exchanging data with the authentication entity, preferably without contact.

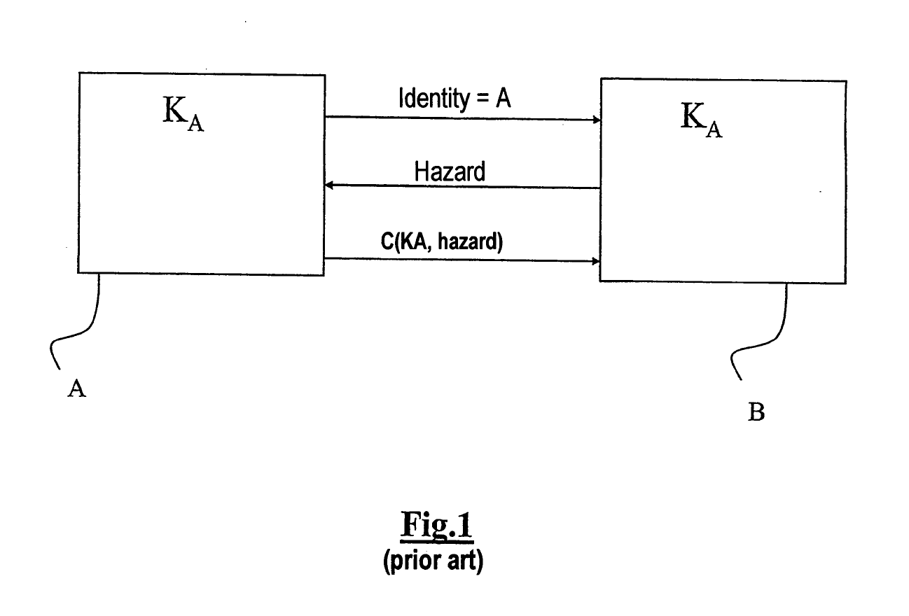

According to the prior art, the authentication by secret key is characterised essentially by succession of the following stages such as illustrated in FIG. 1. Therefore, when a client entity A wishes to be authenticated by an authentication entity B, it initially provides its identity to the entity B, in the form of a static identifier specific to it, and then proves it by utilisation of a secret key K_{A} known and shared by the entities A and B only.

To do this, when the authentication entity B receives an authentication request sent by a client entity presenting as appointed to exercise the identity A, said authentication entity first generates a random number called hazard, or called challenge, and sends this hazard to the client entity A. In return, the client entity digitises, or signs, the received hazard according to a predefined cryptographic algorithm with secret key, such as the DES algorithm (English acronym for Data Encryption Standard). The entity A then sends the value C (K_{A}, hazard) back to the authentication entity B, where C is a cryptographic function.

The entity B at its end makes the same calculation by using the cryptographic function C and the secret key of A K_{A}, and compares the result obtained to the value returned to it by the entity A. In the case of coherence between the expected result and the returned value A, the authentication entity B validates the authentication, thus signifying that A has succeeded in being authenticated. The validation of the authentication translates for example by sending access rights to resources via the authentication entity destined for the client entity A which has been authenticated.

Such authentication methods with secret key are widely distributed over telecommunications network, but still present a certain number of disadvantages in terms of the guarantee of the anonymity of the client entity wishing to be authenticated.

In fact, to initialise the authentication method, a specific identifier of the client entity is necessarily transmitted in plain text to the authentication entity. Thus a malicious third party is able to know the specific identifier of the entity which is being authenticated by observing the transaction between the authentication entity and the entity being authenticated.

Furthermore, the specific identifier of an entity wishing to be authenticated can likewise be deduced by a malicious third party acting this time actively, that is, initialising an authentication process by passing as an authentication entity vis-à-vis the entity being authenticated.

An entity being authenticated can still be recognised by observation of its behaviour and, more particularly by observation of the responses provided by the entity over the course of prior authentication processes.

In fact, the responses provided by an entity being authenticated are characteristic of certain inputs corresponding to the hazards which they have been subjected to by the authentication entity and, for the same input, the entity being authenticated will always provide the same response. In previously observing the response of the entity to values characteristic of hazard, it is possible to recognise an entity being authenticated by again submitting to it one of these hazard values for which a response from the entity has already been observed. Therefore, an entity which signs hazards to be authenticated can be characterised by its response for a particular hazard value (for example 0.10, 100, 1000, etc. . . . ). By observing two successive identifications with the same hazard, it is thus possible to deduce whether these are two distinct entities or the same entity which are being authenticated.

The aim of the present invention is to rectify these disadvantages by proposing an authentication method based on an encryption algorithm with a secret key, in which the anonymity of the entity being authenticated is guaranteed, so that only this legitimate authentication entity may recognise the identity of the entity which is being authenticated and nobody else.

With this objective in sight, the invention relates to an authentication method of at least one client entity by an authentication entity, said authentication entity comprising a set of secret keys, each being associated with a client entity capable of being identified by said authentication entity, said method being characterized in that it comprises the steps following consisting of:

a—transmitting an anonymous authentication request from the part of the client entity to the authentication entity;

b—sending from the authentication entity to the client entity, an authentication counter value corresponding to the current state of a counter of the authentication entity;

c—verifying, at the client entity side, that the authentication counter value received is strictly greater than a counter value stored by the client entity;

d—calculating, at the client entity side, a counter signature by application of a cryptographic function shared by the client entity and the authentication entity, with said authentication counter value and a secret key associated with the client entity as operands;

e—transmitting said counter signature to the authentication entity;

f—updating the counter value stored by the client entity with said authentication counter value;

g—searching, at the authentication entity side, for at least one client entity capable of being identified, for which the corresponding counter signature for said authentication counter value is coherent with the counter signature received;

h—having the authentication counter increase.

Steps b) to h) are preferably repeated at least once, so as to ensure that the client entity identified is identical to each iteration.

According to a particular embodiment, the search step consists of:

i—calculating, for each client entity capable of being identified, the corresponding counter signature by application of the cryptographic function with the authentication counter value and the associated secret key as operands, so as to establish a list of client entity capable of being identified/corresponding counter signature couples, for said counter value;

j—verifying the coherence between the counter signature received and at least one counter signature of said list.

The list of client entity capable of being identified/corresponding counter signature couples established for a given authentication counter value, is preferably sequenced, at the authentication entity side, according to the value of said counter signature.

According to this embodiment, in the case of coherence between the counter signature received and the counter signature of a plurality of couples, steps b) to h) are reiterated until a single couple is obtained for which the counter signature corresponds to the counter signature received.

During repetition of stage i), the counter signature is preferably calculated solely for the client entities corresponding to said plurality of couples determined at the preceding iteration.

In a variant, the method according to the invention consists of implementing step i) as anticipated relative to an authentication request issued from a client entity at step a), said anticipated step i) consisting of pre-establishing, at the authentication entity side, for at least one authentication counter value to come, the list of client entity capable of being identified/corresponding counter signature couples for each of said authentication counter values to come, and storing said pre-established lists at the authentication entity side, any sending from the authentication entity to the client entity of an authentication counter value, corresponding to sending an authentication counter value for which a list of client entity capable of being identified/corresponding counter signature couples has already been pre-established.

Step h) preferably consists of increasing the authentication counter by a fixed rate.

In a variant, step h) consists of increasing the authentication counter by a random rate.

According to a particular embodiment, in response to an authentication request, step b) consists of sending, at the authentication entity side, in addition to the authentication counter value, a random value associated with said counter value, said random value being different for each of the authentication counter values sent, each stage of counter signature utilised throughout said process being replaced by a signature step of the authentication counter value/associated random value couple, consisting of application of the cryptographic function further comprising said associated random value as operand.

According to a variant, step c) consists in addition of verifying that the difference between the authentication counter value received and the counter value stored by the client entity is less than or equal to a predetermined value.

In a variant, when step c) is not verified, the following intermediate steps are implemented, consisting of:
sending the counter value stored by the client entity from the client entity to the authentication entity;
sending a temporary authentication counter value greater than said counter value stored by the client entity from the authentication entity to the client entity, then:
implementing steps d) to g) on the basis of the temporary authentication counter value and, in the event of success of the authentication of said client entity,
updating the authentication counter value corresponding to the current state of the counter of the authentication entity with the authentication counter value temporary and executing step h).

Step e) preferably consists of transmitting the authentication counter value in addition to the authentication entity.

The authentication counter value is preferably coded on at least 128 bits.

The invention likewise relates to a chip card, characterised in that it comprises an integrated circuit and means for storing a secret key and executing the method according to the invention.

It preferably concerns a contactless chip card.

The invention further still relates to an authentication entity of at least one client entity, characterised in that it comprises a chip card reader equipped with means for executing the method according to the invention.

The authentication entity preferably comprises a contactless chip card reader.

Other characteristics and advantages of the present invention will emerge more clearly from the following description given by way of illustration and non-limiting and in reference to the attached figures in which:

FIG. 1 is a sketch illustrating an authentication process by secret key according to the state of the art, and has already been described;

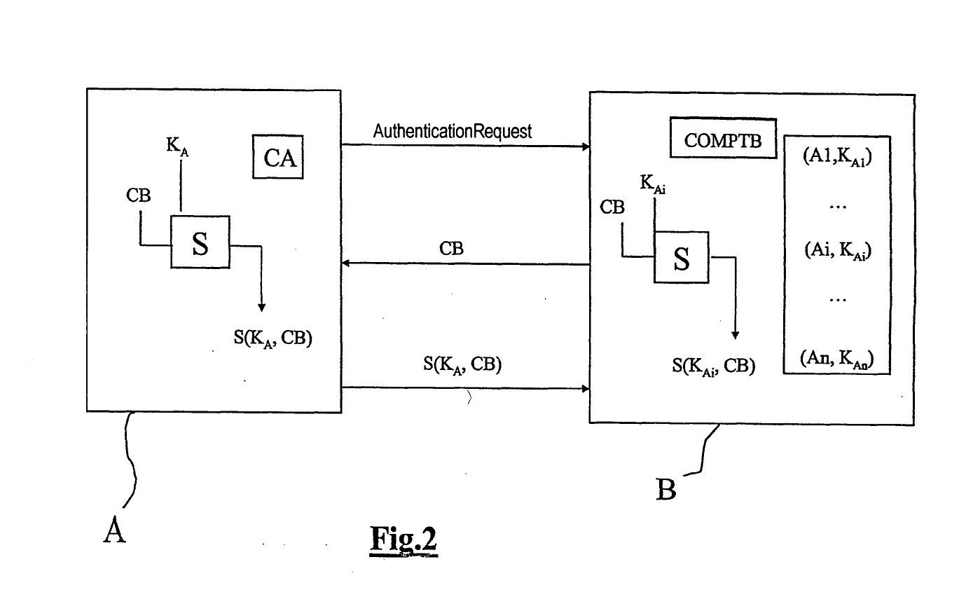

FIG. 2 is a sketch illustrating the principal stages of the authentication process according to the present invention.

FIG. 2 thus describes the principal stages of the authentication process by secret key of a client entity A by an authentication entity B, according to the present invention.

The entity A wishing to be authenticated has a secret key K_{A} which is peculiar to it, storage means of a counter value CA, as well as a cryptographic signature function S, likewise shared by the authentication entity B, and which is provided for applying with the two following operands: a secret key and a counter value, so as to sign the counter value.

The authentication entity B for its part comprises a list of couples (Ai, K_{Ai}), Ai being the name of one of n client entities capable of being authenticated by the authentication entity B and K_{Ai} being the secret key associated with the client entity Ai unique to it.

The authentication entity, likewise comprises a counter COMPTB delivering a counter value CB and the cryptographic function S, identical to that implemented in the client entity A.

The sequence of the anonymous authentication process according to the invention is the following. In a first stage, when the client entity A wants to be authenticated with the authentication entity B, it is signalled to B by transmission of an anonymous authentication request “AuthenticationRequest”. In response, in a second stage, the authentication entity B sends to the client entity A the counter value CB corresponding to the current state of its counter COMPTB.

In a third stage, the client entity A compares the counter value CB received to the counter value CA stored by the client entity A. At this stage, two possibilities are open to the client entity A:

Either CA≧CB, at which the client entity A does nothing more, since this situation signifies that an entity is attempting to replay a signature to the client entity A. Now, according to a characteristic of the invention, so as not to be recognisable by its behaviour, a client entity never signs the same data twice.

This situation thus terminates the authentication method.

Or CA<CB, at which the client entity A can have confidence in the authentication entity B; because the counter value received CB is strictly greater than the counter value stored by A, this signifies that this counter value CB has never been submitted for signature. The process then moves on to the following stage.

In a fourth stage, the client entity A signs the counter value received CB by application of the cryptographic function S with the secret key K_{A} associated with the client entity A and the counter value CB as operands. The result of this operation of counter signature S (K_{A}, CB) is transmitted from the client entity A to the authentication entity B. The client entity A then updates in a fifth stage its stored counter value CA with the last legitimate counter value which has been transmitted to it by the authentication entity B, namely CB.

In a sixth stage, the authentication entity B searches for at least one client entity Ai among the n client entities which it is capable of authenticating, for which the corresponding signature of the counter value CB S (K_{Ai}, CB) is coherent with the counter signature received from the client entity which seeks to be authenticated S (K_{A}, CB).

If no client entity capable of being identified is found, this then means that authentication has failed. Inversely, if just one client entity Ai is found on completion of the search phase for S (K_{Ai}, CB)=S (K_{A}, CB), then the authentication entity B concludes that A=Ai. This means that it is the client entity Ai which has sought to be authenticated by the authentication entity B and that this authentication has succeeded.

In a seventh and final stage competing the authentication method, the authentication entity B increases the counter value CB for the next authentication request.

It is possible that a swindler, by sending a number picked at random, comes across a value S (K_{Ai}, CB) which exists and thus can pass as the client entity Ai. To prevent this risk, the authentication entity B can systematically have the authentication process redone at least a second time so as to ensure that each time it recognises the same client entity. The process can even be repeated N times, until a probability of randomly coming across a signature value N times corresponding to the same sufficiently low client entity.

Likewise, further optimisation of the authentication method relates to managing collusion cases. In fact, at the end of the sixth stage, the result can be a case of collusion, that is, that several client entities Ai likely to be identified by the authentication entity B have been found for which the counter signature S (K_{Ai}, CB) is coherent with the counter signature received S (K_{A}, CB). There is in fact a slight probability, though not zero, for the cryptographic signature function S to provide an identical result for two different data. In this collision situation, it is necessary to repeat the stages of the process from the second stage on, with a counter value CB incremented at each repetition, until a client entity Ai capable of being identified unique is obtained, for which S (K_{Ai}, CB)=S (K_{A}, CB).

The sixth stage, consisting of the search phase by the authentication entity of at least one client entity Ai among the n client entities it is capable of authenticating, for which the corresponding signature of the counter value CB-S (K_{Ai}, CB) is coherent with the counter signature received from the client entity which seeks to be authenticated S (K_{A}, CB), can be deployed as follows. The authentication entity B calculates, for each client entity Ai capable of being identified, the corresponding signature counter S (K_{Ai}, CB) by application of the cryptographic function S with the authentication counter value CB and the secret key associated with K_{Ai} as operands, so as to establish a list of client entity capable of being identified/corresponding counter signature couples (Ai, S (K_{Ai}, CB)), for the current counter value CB.

Once this list is compiled, the authentication entity runs through it to verify if there is at least one client entity capable of being identified Ai verifying S (K_{Ai}, CB)=S (K_{A}, CB).

In the event where several couples (Ai, S (K_{Ai}, CB)) correspond, it was obviously necessary to repeat the sending and signature operations of a counter value CB. Nevertheless, this repetition can even lead to the existence of several couples (Ai, S (K_{Ai}, CB)) which correspond. In this case, there is provision for searching for possible couples only among the couples having already been selected at previous iterations.

Therefore, the process will converge more quickly on a single client entity Ai since, at each iteration, the counter signature S (K_{Ai}, CB) is calculated solely for the client entities Ai corresponding to the couples (Ai, S (K_{Ai}, CB)) selected at the preceding iteration.

At the sixth stage, the phase of calculation by B, for each client entity Ai capable of being identified, of the corresponding counter signature S (K_{Ai}, CB), so as to compile the list of client entity capable of being identified/corresponding counter signature couples (Ai, S (K_{Ai}, CB)), for the current counter value CB can be very long and punishing in terms of response time. To adjust this problem, according to a variant of the invention, it is provided that the authentication entity B, for at least one authentication counter value CB to come, pre-calculates the lists of couples (Ai, S (K_{Ai}, CB)) for these values CB to come and stores these results. Therefore, when a client entity might want to be authenticated by sending the message AuthenticationRequest, the authentication entity B will reply by sending an authentication counter value CB for which the list (Ai, S (K_{Ai}, CB)) will have already been compiled. In general, according to this embodiment, any sending of B to A of a authentication counter value CB will correspond to an authentication counter value for which a list (Ai, S (K_{Ai}, CB)) will have already been compiled.

The verification phase by the authentication entity B, consisting of searching for the existence of at least one client entity Ai of the list (Ai, S (K_{Ai}, CB)) for which S (K_{Ai}, CB)=S (K_{A}, CB), can likewise be very long in the case of sequential search, in theory of the order of n/2 tests with a list comprising n elements. Also, for optimising this phase, the list of couples obtained (Ai, S (K_{Ai}, CB)) can be ordered increasingly (or decreasingly) according to the value of the counter signature S (K_{Ai}, CB). The search for a couple in this ordered list for which the counter signature S (K_{Ai}, CB) corresponds to S (K_{A}, CB) can then be made according to a dichotomic search. The client entity searched for is in this case found on average, after having carried out log₂ (n) operations, which achieves a significant time gain.

The counter CB being unique for each authentication, it can be utilised as identifier of authentication session. Therefore, if several entities Ai are simultaneously being authenticated by the entity B, the latter can distinguish the dialogues because of this value. It suffices for the client entities wanting to be authenticated to return the value CB en plus of the signature value S (K_{A}, CB).

The COMPTB counter providing the authentication counter value CB preferably increases at a fixed rate.

All the same, the fact that the counter CB grows at a fixed rate can provide the authentication counter values which will be utilised during authentications to come. Because of this, a pirate can demand several values S (K_{A}, CB) of an entity A for several counter values CB and, ultimately, seek to be authenticated with the entity B by returning to it the values previously obtained from the client entity A. Therefore, the pirate can be authenticated by passing for A. Two types of parade against such an attack on the authentication system can be utilised.

First, a first parade consists of increasing the COMPTB counter by a random rate at each authentication, so as to no longer utilise successive CB values. In this case, the counter will have to have a larger capacity so as not to come to a stop.

Another parade consists of no longer signing a simple counter value CB to the client entity A seeking to be authenticated, but a couple (CB, hazard), CB incrementing regularly and hazard taking on random values. The random value is provided to be different for each of the authentication counter values sent, and each stage of counter signature used during the authentication process in any one of its variants is then replaced by a signature stage of the couple (CB, hazard), consisting of application of the cryptographic function S with said associated random value as operand, in addition.

The authentication process such as has been described hereinabove is vulnerable to attacks by counter jump, based on the fact that the entities A and B are synchronised to the counter value CB at each authentication. Therefore, a malicious machine can pass for the authentication entity B and send the client entity A wanting to be authenticated a counter value which is much greater than the effective authentication counter value CB, corresponding to the current value of the COMPTB counter of the entity B. By updating its stored counter value CA with this large value which is submitted to it, the entity A will no longer be able to respond to an authentication request since the counter value CB of the authentication entity B will not have made up for this value CA, because of the test of the third stage.

Furthermore, if the malicious machine supplies the entity A with a maximum counter value, by updating its stored counter value CA to this maximum value, the latter becomes definitively unusable thereafter.

The parades to these attacks more particularly refer to the third stage of the authentication process, where the client entity A compares the received counter value CB to the counter value CA stored by the client entity A.

In the case where CA≧CB, according to a variant of the invention, the following intermediate stages are employed:
the entity A signals to the entity B that its stored counter value CA is greater than the value CB and sends it back CA;
the entity B sends to A a temporary counter value CB>CA;

then, the other stages of the authentication process are implemented on the basis of this value of temporary CB and, if authentication of the entity A succeeds with temporary CB, the entity B updates its authentication counter value CB corresponding to the current state of its COMPTB counter with the temporary CB authentication counter value. Finally, the counter is incremented for the next authentication. This process enables the authentication entity to be protected against an attack by counter jump. In fact, it will first authenticate the client entity A with temporary CB, before updating its counter. This process likewise allows the client entity A to synchronise the counter of the authentication entity B with its stored counter value, if the latter had undergone an attack by counter jump.

At this stage, the entity B can also implement additional protective measures. For example, B can authorise only a certain number of these counter synchronisations per client entity and per period. Likewise, B can authorise these protections only within a reasonable period where the difference between the counter value stored by the client entity CA and the authentication counter value CB is less than a predetermined value.

According to another variant, at the third stage of the process, in the case where the relation CA<CB is verified, it is also verified, at the client entity side, that the difference between the received authentication counter value CB and the counter value CA stored by the client entity is less than or equal to a predetermined value A, or CB−CA≦Δ. The entity A accepts signing the counter value CB only if this additional condition is verified. This additional condition allows the client entity A seeking to be authenticated to limit the attacks by counter jump in accepting only one moderated increment of its stored counter value and by ignoring the solicitations utilising an authentication counter value much greater than its stored counter value.

According to an embodiment, the counter values CA and CB can be binary numbers coded on at least 128 bits, which allows executing 2128 authentications before the system arrive at exhaustion of the COMPTB counter.

The stages of the process according to the invention at the client entity side, are for example implemented on a chip card, preferably a contactless chip card. A chip card for executing stages of the process according to the invention requires only minor calculating capacity as far as the operations to be executed are simple (at most the signature of a counter). The authentication entity is thus present in the form of a chip card reader with or without contact.

Advantageously, due to the process according to the invention, only a legitimate authentication entity can recognise the identity of the client entity seeking to be authenticated. The identity of the client entity A seeking to be authenticated is known only from the authentication entity B and is never revealed during authentication. Furthermore, the client entity A does not know under which name it is identified by the authentication entity. The entity which is being authenticated has in fact no static identity which could be revealed.

On the other hand, by ensuring that an entity refuses to be authenticated in the presence of a question which has already been submitted to it, a malicious third party is incapable of distinguishing entities. In view of two successive authentications, it is not possible to say whether these are two distinct entities or the same entity which are being authenticated. Anonymity is thus complete.

1-18. (canceled)

19. An authentication method of at least one client entity by an authentication entity, the authentication entity comprising a set of secret keys, each secret key associated with a client entity identifiable by the authentication entity, the method comprising the following steps:
a—transmitting an anonymous authentication request from a part of the client entity to the authentication entity;
b—sending, from the authentication entity to the client entity, an authentication counter value corresponding to a current state of a counter of the authentication entity;
c—verifying, at a client entity side, that the authentication counter value received is strictly greater than a counter value stored by the client entity;
d—calculating, at the client entity side, a counter signature by applying a cryptographic function shared by the client entity and the authentication entity, wherein the authentication counter value and a secret key associated with the client entity are operands;
e—transmitting the counter signature to the authentication entity;
f—updating the counter value stored by the client entity with the authentication counter value;
g—searching, at an authentication entity side, for at least one identifiable client entity for which a corresponding counter signature for the authentication counter value is coherent with the counter signature received; and
h—increasing the authentication counter.

20. The authentication method of claim 19, wherein steps b) to h) are reiterated at least once to verify that the client entity identified is identical at each iteration.

21. The method of claim 19, wherein the step of searching further comprises:
i—calculating, for each identifiable client entity, the corresponding counter signature by applying the cryptographic function with the authentication counter value and the secret key associated with as operands to compile a list of identifiable client entities and corresponding counter signature couples, for the counter value; and
j—verifying coherence between the counter signature received and at least one counter signature of the list.

22. The authentication method of claim 21, wherein the list of identifiable client entities and corresponding counter signature couples compiled for a given authentication counter value is ordered, at the authentication entity side, according to the value of the counter signature.

23. The authentication method of claim 21, wherein in a case of coherence between the counter signature received and the counter signature of a plurality of couples, steps b) to h) are reiterated until a single couple is obtained for which the counter signature corresponds to the counter signature received.

24. The authentication method of claim 23, wherein, during reiteration of step i), the counter signature is calculated solely for the client entities corresponding to the plurality of couples determined in the preceding iteration.

25. The authentication method of claim 21, including implementing step i) as anticipated relative to an authentication request from a client entity at step a), wherein anticipated step i) comprises
pre-establishing, at the authentication entity side, at least one authentication counter value to come, the list of identifiable client entities and corresponding counter signature couples for each of the authentication counter values to come, and
storing the pre-established lists at the authentication entity side, wherein any sending from the authentication entity to the client entity of an authentication counter value corresponds to sending an authentication counter value for which a list of identifiable client entities and corresponding counter signature couples has already been pre-established.

26. The authentication method of claim 19, wherein step h) includes increasing the authentication counter by a fixed rate.

27. The authentication method of claim 19, wherein step h) includes increasing the authentication counter by a random rate.

28. The authentication method of claim 19, wherein, in response to an authentication request, step b) comprises
sending, at the authentication entity side and in addition to the authentication counter value, a random value associated with the counter value, wherein the random value is different for each of the authentication counter values sent, and wherein each step of counter signature carried out during the method is replaced by a signature step of the authentication counter value and associated random value couple, including application of the cryptographic function further comprising the associated random value as operand.

29. The authentication method of claim 19, wherein step c) includes verifying that the difference between the received authentication counter value and the stored counter value by the client entity is less than or equal to a predetermined value.

30. The authentication method of claim 19, wherein, with step c) not being verified, the following intermediate steps are implemented:
sending the counter value stored by the client entity from the client entity to the authentication entity;
sending a temporary authentication counter value greater than the counter value stored by the client entity from the authentication entity to the client entity, then:
implementing steps d) to g) on the basis of the temporary authentication counter value and, in the case of success of authentication of the client entity,
updating the authentication counter value corresponding to the current state of the counter of the authentication entity with the temporary authentication counter value, and executing step h).

31. The authentication method of claim 19, wherein step e) includes transmitting the authentication counter value in addition to the authentication entity.

32. The authentication method of claim 19, wherein the authentication counter value is coded on at least 128 bits.

33. A client entity comprising means for storing a secret key and executing the method of claim 19.

34. The client entity of claim 33, comprising a chip card.

35. The client entity of claim 34, wherein the chip card comprises a contactless chip card.

36. An authentication entity of at least one client entity, comprising a chip card reader including means for executing the method of claim 19.

37. The authentication entity of claim 36, wherein the chip card reader comprises a contactless chip card reader.
